(19) United States
(12) Patent Application Publication
(10) Pub. No.: US 2019/0285158 A1
(43) Pub. Date: Sep. 19, 2019

(54) FINAL DRIVE FOR A MOTOR VEHICLE

(71) Applicant: AUDI AG, Ingolstadt (DE)

(72) Inventor: Christian MEIXNER, Ingolstadt (DE)

(73) Assignee: AUDI AG, Ingolstadt (DE)

(21) Appl. No.: 16/337,512

(22) PCT Filed: Sep. 19, 2017
(86) PCT No.: PCT/EP2017/073577

§ 371 Date: Mar. 28, 2019

(30) Foreign Application Priority Data
Sep. 28, 2016 (DE) 10 2016 218 727.9

(51) Int. Cl. F16H 57/021; B60K 17/16; B60K 17/24; B60B 35/14; B60B 35/12; F16H 57/038

(52) U.S. Cl. CPC F16H 57/021; B60K 17/165; B60K 17/24; B60Y 2410/10; B60B 35/122; F16H 57/038; B60B 35/14

(57) ABSTRACT

A final drive for a motor vehicle, having a first input shaft, a second input shaft, a first output shaft and a second output shaft, wherein the first input shaft is permanently coupled to the first output shaft by means of a first ring gear drive, and the second input shaft is permanently coupled to the second output shaft by means of a second ring gear drive. It is thus provided that the first input shaft and the second input shaft are arranged coaxially with one another and that the first output shaft and the second output shaft extend in opposite directions from the respective ring-gear drive, wherein an axial plane accommodates the rotational axes of the input shafts and a plane perpendicular to the axial plane forms an angle of at least 75° and at most 90°.

The invention relates to a final drive for a motor vehicle, having a first input shaft, a second input shaft, a first output shaft and a second output shaft, wherein the first input shaft is permanently coupled to the first output shaft by means of a first ring-gear drive and the second input shaft is permanently coupled to the second output shaft by means of a second ring-gear drive.

The final drive is associated with an axle of the motor vehicle, e.g., a front axle, but preferably a rear axle of the motor vehicle. By means of the final drive, a torque is transmitted from a drive unit of the motor vehicle to the wheels of the motor vehicle. In other words, an operative connection between the drive unit of the motor vehicle and the axle or its wheels is established, or at least can be established, via the final drive. The drive unit is permanently coupled or at least can be coupled to the first input shaft and the second input shaft. For example, the operative connection between the drive device and the two input shafts is via a transmission unit that is different from the final drive. The transmission unit can be designed, e.g., as a differential gear, in particular an axle differential gear. The two input shafts may be cardan shafts, or at least be coupled to cardan shafts, in particular permanently.

For example, the two input shafts of the final drive are permanently, especially rigidly, coupled to the output shafts of the transmission unit. The two output shafts of the final drive are provided on the wheel side, i.e., arranged with regard to a torque flow on one side of the ring-gear drive facing away from the drive unit. The first output shaft is for example associated with a first wheel of the axle and the second output shaft is associated with at least a second wheel of the same axle, in particular permanently and/or rigidly coupled thereto. Of course, however, it may be provided that the operative connection between the first output shaft and the first wheel and/or the operative connection between the second output shaft and the second wheel can be interrupted at least temporarily. For this purpose, a clutch, e.g., a claw clutch, may be provided in the operative connections.

Within the final drive, the first input shaft is permanently coupled to the first output shaft and the second input shaft is permanently coupled to the second output shaft.

This is done by the first ring gear and the second ring-gear drive. By means of the ring-gear drive, the input shafts and output shafts are arranged at an angle to one another. For example, it may be provided that the ring-gear drives each have a hypoid offset, such that the output shafts are arranged offset relative to the input shafts, in particular skewed thereto, i.e., arranged at a distance parallel to them However, this results in a large installation space requirement for the final drive.

It is an object of the invention to propose a final drive for a motor vehicle, which has advantages over known final drives, in particular has a smaller installation space requirement.

This is realized according to the invention with a final drive with the features of claim 1. The first input shaft and the second input shaft are arranged coaxially with one another, and the first output shaft and the second output shaft extend in opposite directions from the respective ring gear, wherein an axial plane contains the rotational axes of the input shafts, and a plane perpendicular to the axial plane forms an angle of at least 75° and not more than 90° with the rotational axes of the output shafts, and in that a bearing element secured to the transmission housing is arranged in a transmission housing of the final drive, whereby a first ring gear rigidly connected to the first output shaft of the first ring-gear drive is mounted on the first bearing projection, and a second ring gear of the second ring-gear drive rigidly connected to the second output shaft of the second ring-gear drive is mounted on the second bearing projection.

Altogether, initially a special arrangement of the input shafts and the output shafts is thus provided. This, in turn, enables a special bearing arrangement of the ring gears, i.e., the first ring gear and the second ring gear on the bearing element. First, the two input shafts are arranged coaxially with one another. For example, the second input shaft extends in the first input shaft or vice versa. The two output shafts are situated substantially opposite one another, in particular relative to the plane of symmetry, and each extend from the respective ring gear in opposite directions, preferably in the direction of the corresponding wheel of the motor vehicle.

Both the rotational axis of the first output shaft and the rotational axis of the second output shaft intersect, e.g., the two rotational axes of the input shafts and the combined rotational axis of the input shaft. In other words, it is provided that rotational axes of the output shafts intersect each of the rotational axes of the input shafts. Accordingly, the ring gear may be designed without hypoid offset. However, an embodiment with hypoid offset is also achievable, wherein at least the rotational axis of one of the output shafts consequently does not intersect the rotational axes of the input shafts. Preferably, however, in this case the rotational axes of both output shafts do not intersect the rotational axes of the input shafts. This results in a skewed arrangement of the rotational axes of the output shafts with respect to the rotational axes of the input shafts.

Moreover, it is now provided that the (imaginary) axial plane should contain the rotational axes of the input shafts. The axial plane is arranged substantially horizontally with respect to an installation position of the final drive. Accordingly, the plane perpendicular to the axial plane, which likewise contains the rotational axes of the input shafts, is in the form of a vertical plane, i.e., it is arranged substantially vertically in the mounting position of the final drive. The plane perpendicular to the axial plane forms an angle of at least 75° and not more than 90° with the rotational axes of the output shafts, at least in section, i.e., in particular in cross-section with respect to the rotational axes of the input shafts.

Each of the rotational axes thus forms an angle with the plane which meets the above requirements. The angles between the rotational axes and the plane may be identical, or alternatively different. For example, the angle or angles are at least 75° and not more than 90°. Preferably, the angle or angles are at least 80°, at least 85°, at least 86°, at least 87°, at least 88° or at least 89°, but always not more than 90°. This means that the angle or angles can be exactly equal to 90° or less than 90°.

In addition or alternatively, the plane perpendicular to the axial plane is the plane of symmetry for the rotational axes of the output shafts, at least in section, in particular in cross-section with respect to the rotational axes of the input shafts, In this case, the rotational axes of the output shafts are arranged or aligned symmetrically with respect to the plane of symmetry.

In order to design the final drive particularly compact, the bearing element is arranged in the transmission housing. The bearing element has the two bearing projections, i.e., the first bearing projection and the second bearing projection. The bearing projections are used to support the ring gears of the two ring-gear drives. the first ring gear of the first ring-gear drive is mounted on the first bearing projection, and the second ring gear of the second ring-gear drive is mounted on the second bearing projection.

The bearing is preferably designed directly, such that the respective ring gear is seated on the corresponding bearing projection. Alternatively, however, only an indirect bearing can be provided, in which, e.g., the ring gears are mounted on the bearing projection via the respective output shaft. In such an embodiment, the output shaft is mounted directly on or at the bearing projection. The bearing of the respective ring gear is provided only indirectly via the output shaft. For example, the ring gear may be arranged at a distance of the bearing projection in the axial direction with respect to its rotational axis or the rotational axis of the output shaft. The first ring gear is rigidly connected to the first output shaft or, alternatively, designed in one piece therewith. This can be provided in analogous fashion for the second ring gear and the second output shaft.

The bearing element is a device designed separately from the transmission housing. First, the transmission housing and the bearing element are thus made separately from each other and then the bearing element is arranged on or in the transmission housing. The bearing element is preferably arranged in a centered fashion in the transmission housing, in particular in a centered fashion with respect to the rotational axes of the two input shafts. In particular, the rotational axes of the two input shafts extend through the bearing element, thus intersecting it. In order to allow for a simple arrangement of the bearing element in the transmission housing, it is preferably designed in several parts, e.g., it has a first housing shell and a second housing shell. The two bearing projections, e.g., are round in cross-section with respect to their respective longitudinal center axis and preferably extend from a center dome of the bearing element in the axial direction The ends of the bearing projections facing away from the center dome are preferably exposed.

A further development of the invention provides that the rotational axes of the two input shafts and the rotational axes of the two output shafts lie in the axial plane. This represents a particularly advantageous orientation of the input shafts and the output shafts, which allows for an extremely compact design of the final drive. If both the input shafts and the output shafts are arranged in the axial plane, the definition described above using the symmetry plane can be omitted It is no longer necessary for defining the axial plane. A further embodiment of the invention provides that the first bearing projection protrudes in the direction of a first outlet recess of the transmission housing, and the second bearing projection protrudes in the direction of a second outlet recess of the transmission housing or protrudes into it. In this respect, the first outlet recess is associated with the first bearing projection, and the second outlet recess is associated with the second bearing projection. The first outlet recess is preferably penetrated by the first bearing projection and/or the first output shaft. In particular, the first bearing projection and/or the first output shaft protrude out of the transmission housing through the outlet recess. Analogously, this may be the case for the second output recess, as well as for the second bearing projection and the second output shaft.

In this respect, it may be provided that the second outlet recess is penetrated by the second bearing projection and/or the second output shaft, such that the second bearing projection and/or the second output shaft protrude from the gear housing through the second outlet recess. The two outlet recesses are designed in the transmission housing. In particular, both outlet recesses are edge-closed recesses in the transmission housing, i.e., they have a continuous edge in at least one direction. If the gearbox housing is designed in several parts, then each of the outlet recesses is preferably located partly in the first housing shell and partly in the second housing shell, such that the two housing shells form or define each of the outlet recesses at least in certain areas. Accordingly, the housing shells together define the exit recesses.

A development of the invention provides that the gear housing has a first housing shell and a second housing shell, which are formed separately from each other and rest against each other in a contact plane, which lies in the axial plane or parallel thereto.

In this respect, the above-mentioned, multi-part design of the transmission housing should be realized. For this purpose, the transmission housing has the first housing shell and the second housing shell. The arrangement or alignment of the input shafts and the output shafts described above makes it possible to divide the transmission housing into the first housing shell and the second housing shell in a plane substantially horizontal with respect to the installation position of the transmission, which plane is referred to below as the contact plane. This contact plane lies in the axial plane or parallel thereto. In this specification, the focus is not on the horizontal orientation of the contact plane, but rather on its position relative to the axial plane, in order to realize a self-contained definition for the final drive.

The first housing shell and the second housing shell lie against each other in the contact plane or meet each other in the contact plane. Preferably, the first housing shell now lies with a first contact surface against a second contact surface of the second housing shell. The first contact surface and the second contact surface are preferably flat. Particularly preferably, both the first contact surface and the second contact surface are each situated in areas on opposite sides of the plane of symmetry. The contact surfaces are preferably situated completely in the contact plane, but intersected by it.

A preferred embodiment of the invention provides that the first housing shell and the second housing shell are screw-bolted together, wherein a longitudinal center axis of the screw is angled relative to the contact plane, in particular perpendicular thereto. The screw engages both in the first housing shell and the second housing shell. For example, a head of the screw bears against a first of the [two] housing shells, i.e., on the side facing away from the respective other housing shell. On the other hand, a screw thread at a distance from the head engages in the other of the [two] housing shells, such that they are held reliably together. A plurality of such screws, which are spaced apart from each other on the transmission housing, is of course particularly preferred.

The longitudinal center axis of the screw is angled with respect to the contact plane. It being perpendicular thereto is particularly preferred. Such a design allows for a particularly compact final drive, in that no mounting flanges projecting upward and downward are needed on the housing shells in order to secure the two housing shells together. Instead, the mounting flanges may be located on the side of the transmission housing, particularly in the contact plane or parallel thereto. Accordingly, the screw may be in the contact plane or pass through it. Thus, not only the longitudinal center axis of the screw is preferably perpendicular to the contact plane. Rather, the contact plane extends through the screw.

A development of the invention provides that the first housing shell has a flat first contact surface located in the contact plane and the second housing shell has a flat second contact surface located in the contact plane, wherein the first contact surface and the second contact surface lie flat against each other. The housing shells are arranged adjacent to each other. The two contact surfaces of the housing shells are in physical contact with each other. Both the first contact surface and the second contact surface is flat. Each are preferably located completely in the contact plane. For example, the whole first contact surface bears against the second contact surface, or vice versa. In particular, the whole first contact surface bears against the whole second contact surface, such that full-surface contact is established between the contact surfaces.

Alternatively, the first contact surface and the second contact surface may each be flat and lie in an imaginary plane. Both of these imaginary planes should now be angled towards the contact plane, i.e. form an angle therewith that is greater than 0° and less than 90° Preferably, the angle is significantly less than 90°, e.g., it is at most 80°, at most 70°, at most 60°, at most 50°, at most 45°, at most 40°, or at most 30°.

A further preferred embodiment of the invention provides that the screw extend through the first contact surface and/or the second contact surface. The two contact surfaces are held together or pressed against each other by the screw after assembly of the transmission housing. The screw is not arranged at a distance from the contact surfaces, e.g., on a mounting flange separate from the contact surfaces. Rather, the screw is arranged in a screw hole, which extends through the first contact surface and/or the second contact surface, preferably closed at the edges.

A further preferred embodiment of the invention provides that the bearing element is secured to the first housing shell, as well as to the second housing shell, in particular on opposite sides of the contact plane, or by means of at least one screw, whose longitudinal center axis is angled relative to the contact plane and/or is perpendicular thereto. As explained above, the bearing element is attached to the transmission housing. The attachment should not be exclusively on one of the housing shells, but rather on both housing shells. On a first side, the bearing element is located on the first housing shell, and on a second side opposite the first side, [it is located] on the second housing shell. The bearing element is preferably secured to the first housing shell and the second housing shell on opposite sides of the contact plane.

The securing of the bearing element on the first housing shell is thus realized on a first side of the contact plane, and the securing of the bearing element on the second housing shell [is realized] on a second side of the contact plane opposite the first side.

In addition or alternatively, it may be provided that the securing of the bearing element to the first housing shell and/or the second housing shell is realized (each) by means of at least one screw. The longitudinal center axis of the screw or the longitudinal center axes of the screws should now be angled with respect to the contact plane, i.e., form an angle therewith, which is greater than 0° and less than 180°. Particularly preferably, the longitudinal center axis or the longitudinal center axes is/are perpendicular to the contact plane, such that an angle of 90° is present.

A further version of the invention provides that the bearing element is secured to the first housing shell and/or the second housing shell on either side of an imaginary plane, which is arranged vertically on the contact plane and contains an intersection of the output shafts with the rotational axes of the input shafts. The imaginary plane is perpendicular to the contact plane and contains the point of intersection. In addition or alternatively, the rotational axes of the two input shafts lie in the imaginary plane. The imaginary plane is thus a vertical plane with respect to the mounting position of the final drive. is realized, e.g., by having the screws described above on both sides of the imaginary plane. In particular, the longitudinal center axis of the screw is in the imaginary plane.

In addition or alternatively, it can be provided that the bearing element bears on the first housing shell or the second housing shell on either side of the imaginary plane. Particularly preferably, the bearing element is thus supported on either side of the plane on the first housing shell. In addition or alternatively, it is supported on either side of the plane on the second housing shell.

A further preferred embodiment of the invention provides that the first input shaft and the second input shaft, as well as the first output shaft and the second output shaft are each mounted on and/or in the transmission housing. Bearings are provided for mooting the input shafts and the output shafts, which are arranged fixedly with respect to the gear housing. Each shaft, for example, is associated with one of these bearings. However, it can also be provided that both the first output shaft and the second output shaft are each supported by means of a first bearing and a second bearing.

In principle, the two bearings may be arranged anywhere in relation to each other; in particular, they are arranged at a distance from each other in the axial direction with respect to the respective rotational axis of the corresponding output shaft. The first bearing and the second bearing can, for example, be arranged relative to one another in an O configuration, a tandem configuration or, or an X configuration Alternatively, the first bearing and the second bearing may be in the form of a fixed bearing and a floating bearing. Preferably, the input shafts and the output shafts are at least each partially present in the gearbox housing. The ring gears, in particular the ring gears of the ring-gear drive, are preferably completely contained in the gear housing.

A further embodiment of the invention may provide that the first input shaft and the second input shaft are mounted on opposite sides of the ring-gear drive on or in the transmission housing. The sides, on which the input shafts are mounted, are located in the axial direction with respect to the ring-gear drive. In other words, the first input shaft and the second input shaft are mounted on opposite sides of the point of intersection or points of intersection of the rotational axes of the output shafts with the input shafts on or in the gearbox housing. The first input shaft is mounted on a first side and the second input shaft on a side opposite the first side. The first input shaft is preferably mounted only on the first side, while the second input shaft is mounted both on the first side and the second side.

A further embodiment of the invention provides that at least one bearing arrangement for supporting the first ring gear on the first bearing projection and a second bearing arrangement for supporting the second ring gear on the second bearing projection are made and/or secured in at least one direction by means of a respective fastening means, in particular a snap ring. Each of the bearing arrangements can in principle be configured as desired. Insofar as only one of the bearing arrangements is discussed, the corresponding embodiments are preferably always transferable to the respective other embodiment. The bearing arrangement has, for example, at least one radial bearing, in particular several radial bearings. If several radial bearings are provided, they are arranged in, e.g., an O configuration. Alternatively, they can also be designed as fixed bearings and as floating bearings. In the latter case, one of the radial bearing forms the fixed bearing and the respective other radial bearing forms the floating bearing.

For example, the radial bearing or the radial bearings is/are arranged on the bearing projection associated with the respective ring gear. This means that it is seated with its inner ring or with their inner rings on the respective bearing projection. An outer ring of the radial bearing or outer rings of the radial bearings is/are arranged in the ring gear and/or the respective output shaft. Accordingly, the outer ring(s) is/are in contact with an inner bearing surface of the ring gear and/or output shaft. It may be provided that the fastening means is associated with the bearing arrangement, whereby it or one of its radial bearings is fixed in the axial direction with respect to an rotational axis of the respective ring gear. The fastener may be in the form of, e.g., a snap ring, which preferably engages in an at least partially, in particular completely circumferential groove of the respective bearing projection.

Finally, it can be provided within the scope of a further preferred embodiment of the invention that the bearing element is designed in one piece and/or of the same material. The bearing element, i.e., its center dome is made in one part with two bearing projections. Preferably, the center dome and the two bearing projections are made of the same material, i.e., are of the same material.

A preferred embodiment of the invention may also provide that the bearing element is at least partially present as a hollow body. This allows for a particularly weight-saving design of the final drive. Moreover, by designing the bearing element as a hollow body, e.g., a passage opening for one of the input shafts, in particular the second input shaft, is created. For example, ring gears of the two ring gears, which are rigidly connected to the input shafts, are arranged on opposite sides of the bearing element in the axial direction with respect to the rotational axes of the input shafts [somewhat uncertain referential terms] This means that at least one of the input shafts fully penetrates the bearing element in the axial direction.

The invention will be explained in more detail with reference to the embodiments shown in the drawings, without limiting invention in any way. In the drawings:

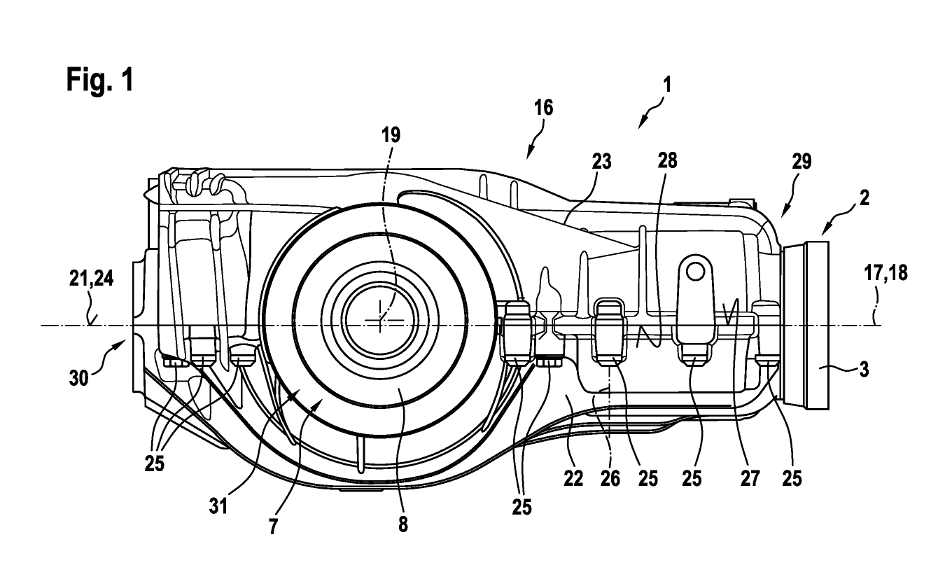

FIG. 1 is a schematic side view of a final drive of a motor vehicle,

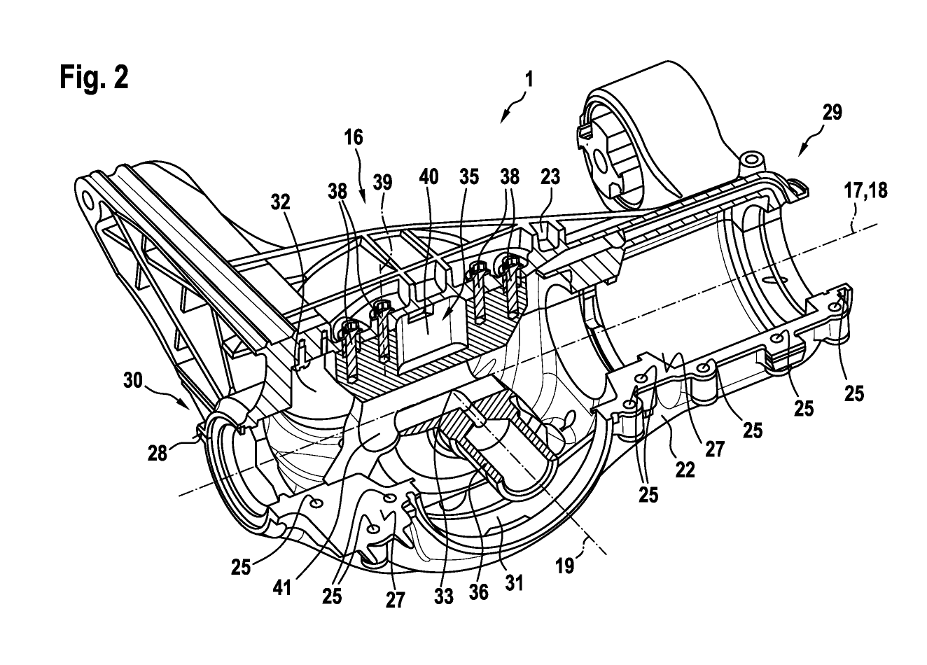

FIG. 2 is a schematic sectional view of a transmission housing, as well as a bearing element arranged in the transmission housing,

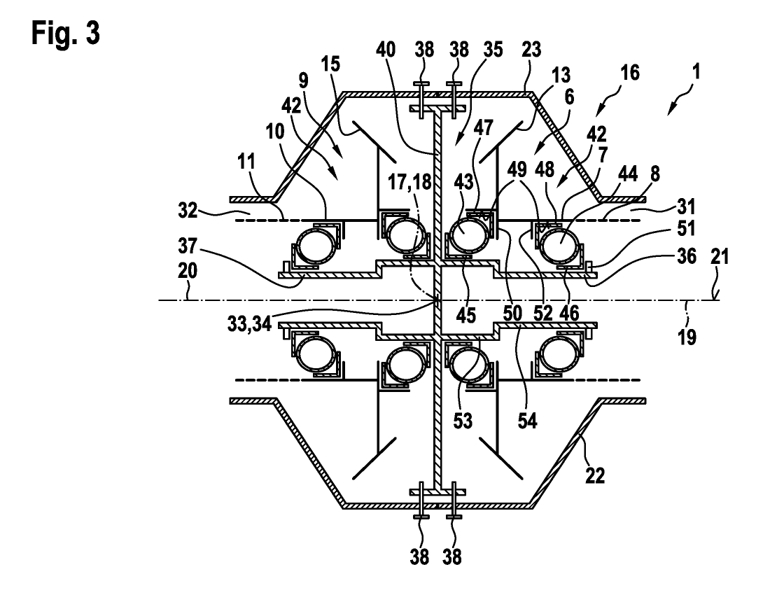

FIG. 3 is a schematic representation of the final drive in a first embodiment,

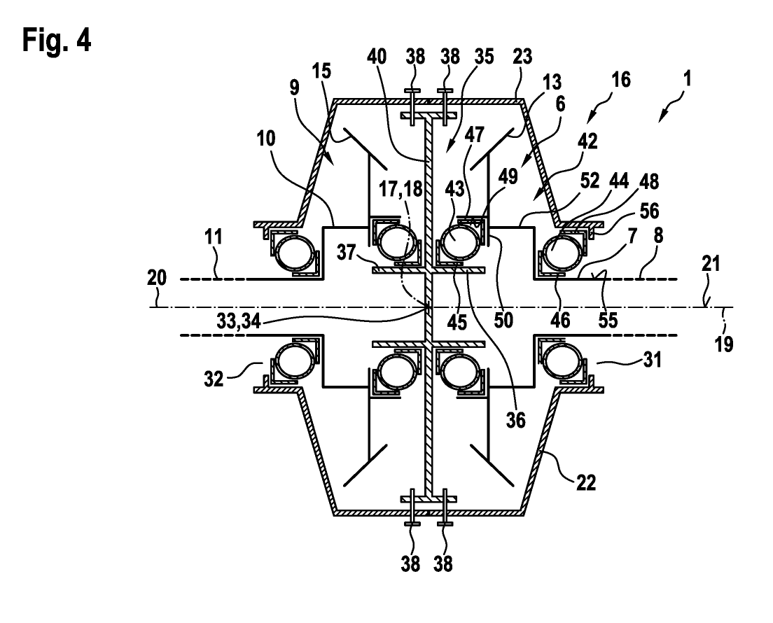

FIG. 4 a schematic representation of a second embodiment of the final drive,

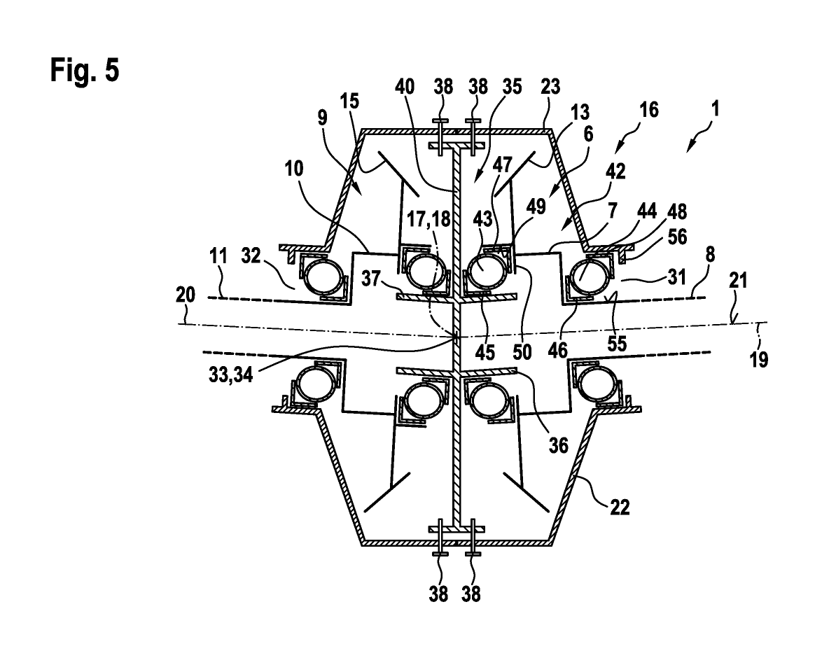

FIG. 5 is a first variant of a third embodiment of the final drive in a schematic representation, and

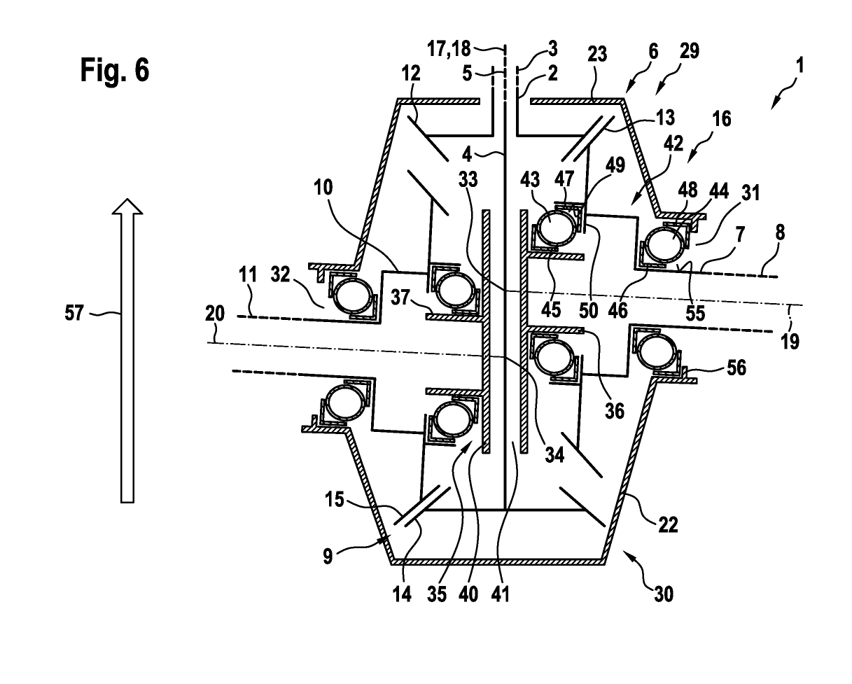

FIG. 6 is a schematic representation of a second embodiment of the third embodiment of the final drive.

FIG. 1 is a schematic side view of a final drive 1 for a motor vehicle. This has a first input shaft 2, of which a connection flange 3 is shown here. Coaxially to the first input shaft 2, a second input shaft 4, not visible here, is arranged. The first input shaft 2 is designed as a hollow shaft and the second input shaft 4 is arranged and/or mounted in the first input shaft 2. The second input shaft 4 has a connection flange 5, which is preferably arranged in the connection flange 3 of the first input shaft 2. The first input shaft 2 is permanently coupled to a first output shaft 7 by means of a first ring-gear drive 6. The first output shaft 7 has a connection flange 8, which can be seen here.

Similarly, the second input shaft 4 is permanently coupled by means of a second ring-gear drive 9 to a second output shaft 10, not visible here, which has a connecting flange 11.

The first ring gear 6 consists of a ring gear 12 rigidly and permanently coupled to the first input shaft 2, and a ring gear 13 meshing with the ring gear 12 and permanently and rigidly coupled to the first output shaft 7. Similarly, the second ring-gear drive 9 has a ring gear 14 rigidly and permanently coupled to the second input shaft 4, and a ring gear 15 meshing with the ring gear 14 and rigidly and permanently coupled to the second output shaft 10. The ring-gear drives 6 and 9 and correspondingly the ring gears 12, 13, 14 and 15 are arranged in a gear housing 16 of the final drive 1, in particular completely. In other words, the transmission housing 16 preferably completely encloses the ring-gear drives 6 and 9.

It has already been pointed out that the first input shaft 2 and the second input shaft 4 are arranged coaxially with one another, the second input shaft 4 being in the first input shaft 2. The input shafts 2 and 4 thus have coincident rotational axes 17 and 18. The first output shaft 7 and the second output shaft 10 now extend in opposite directions from the respective ring-gear drives 6 and 9. In the exemplary embodiment shown here, the first output shaft 7 thus extends out of the drawing plane, while the second output shaft 10 extends into the drawing plane. A rotational axis 19 of the first output shaft 7 or each connecting flange 8 is arranged slightly obliquely in the vertical direction and intersects the rotational axes 17 and 18. The same applies to a rotational axis 20, which is not visible here, of the second output shaft 10 or its connecting flange 11.

The input shafts 2 and 4 or their rotational axes 17 and 18 lie in an axial plane 21, which is basically arranged horizontally. In other words, an imaginary plane is perpendicular to the axial plane 21, which is seen in section, especially in cross-section with respect to the rotational axes 17 and 18, as a plane of symmetry for the rotational axes 19 and 20 of output shafts 7 and 10. The rotational axes 19 and 20 are arranged and aligned symmetrically to this imaginary plane, which can also be referred to as a vertical plane due to the horizontal arrangement of the axial plane 21.

Because the imaginary plane serves as a plane of symmetry for the rotational axes 19 and 20, the rotational axes 19 and 20 intersect both the plane of symmetry and the axial plane at the same angle. In other words, the rotational axis 19 with respect to the axial plane 21 or the plane of symmetry is at a first angle, and the rotational axis 20 with respect to the axial plane 21 or the plane of symmetry is at a second angle, whereby the two angles are equal. In general, the rotational axes 19 and 20 thus intersect the axial plane 21. It can also be provided that the rotational axes 19 and 20 lie completely in the axial plane 21.

In order to realize a space-saving design of the final drive 1, the transmission housing 16 is embodied in several parts and has a first housing shell 22 and a second housing shell 23, which are designed separately from one another and rest against each other in a contact plane 24, which lies in axial plane 21 or parallel thereto. The first housing shell 22 and the second housing shell 23 are fastened together by means of at least one screw 25, in the embodiment shown here, by means of a plurality of screws 25. At least one of the screws 25, but preferably all of the screws 25, now has a longitudinal center axis 26, which is angled with respect to the contact plane 24, i.e., intersects it at a certain angle.

In this respect, it is not provided that the screw 25 or its longitudinal center axis 26 be arranged parallel to the contact plane 24 or that the longitudinal center axis 26 be located in the contact plane 24. Rather, it is particularly preferred, that the longitudinal center axis 26 be perpendicular to the contact plane 24. In addition, it is preferably provided that at least one of the screws 25 is penetrated by the contact plane 24, i.e., intersected cut by the contact plane 24.

For the arrangement of screw 25, this means that it is located on the side of the gear housing 16 and not on a separate mounting flange, which would be provided together on an upper or a lower side of the gear housing 16 for mounting shells 22 and 23. Such a mounting flange is simply not provided in the advantageous embodiment of the final drive 1 described here. With such a design, the installation space required in the vertical direction, i.e., the plane of symmetry, can be substantially reduced compared with other final drives 1.

The first housing shell 22 has a flat first contact surface 27 located in the contact plane 24 and the second housing shell 23 has a flat second contact surface 28 located in contact plane 24. After mounting the housing shells 22 and 23, the two contact surfaces 27 and 28 lie flat against each other, especially over their entire surface. Full-surface arrangement means that the whole first contact surface 27 is in contact with the whole second contact surface 28. Each of the contact surfaces 27 and 28 fully covers the respective other contact surface 28 and 27.

The screw 25 now passes through both the first contact surface 27 and the second contact surface 28. It thus engages both the first housing shell 22 and the second housing shell 23 in order to fasten them together. In the exemplary embodiment shown here, it is provided that the first contact surface 27 extends in the direction of the rotational axes 17 and 18 from one end 29 of the transmission housing 16 to its other end 30. In addition or alternatively, this applies to the second contact surface 28. Thus, particularly preferably, both the first contact surface 27 and the second contact surface 28 extend to the end 29, on the one hand, and to the end 30, on the other.

However, the contact surfaces 27 and 28 may be interrupted between the ends 29 and 30 In the exemplary embodiment shown here, this is the case for both contact surfaces due to a first outlet recess 31 for the first output shaft 7 or its connecting flange 8, and a second outlet recess 32 for the second output shaft 10 or its connecting flange 11. The first output shaft 7 thus passes through the first outlet recess 31 or is arranged therein, while the second output shaft 10 passes through the second outlet recess 32 or is arranged therein.

It is particularly preferred that the outlet recesses 31 and 32 are formed in equal parts in the housing shell 22 and the second housing shell 23. At least, however, each of the outlet recesses 31 and 32 is at least partially located in the first housing shell 22, and at least partially located in the second housing shell 23. The contact surfaces 27 and 28 thus each have two partial surfaces which, when viewed in the axial direction with respect to the rotational axes 17 and 18, are located on opposite sides of the outlet recesses 31 and 32.

FIG. 2 shows a schematic partial sectional view of a part of the final drive 1. The input shafts 2 and 4 and the output shafts 7 and 10 are not shown here. This also applies to the ring-gear drives 6 and 9. Basically, however, reference is made to the above explanations. It is clearly evident here that the rotational axis 19 intersects the rotational axes 17 and 18 at an intersection point 33. This also applies analogously to the rotational axis 20 at an intersection point 34, not shown here, whereby this point may coincide with the intersection point 33.

Furthermore, it can now be seen that a bearing element 35 is arranged in the gear housing 16 in a preferred embodiment of the final drive 1. It has a first bearing projection 36, as well as a second bearing projection 37 opposite thereto, and which is not visible here. On the first bearing projection 36, the first ring gear 13 rigidly connected to the first output shaft 7 is rotatably mounted, and on the second bearing projection 37, the ring gear 15 rigidly connected to the second output shaft 10 of the second ring gear 9 is rotatably mounted. The first bearing projection 36 thus protrudes in the direction of the first outlet recess 31, in particular into it, or even penetrates it in the direction of the rotational axis 19. Conversely, the second bearing protrusion 37 protrudes in the direction of the second outlet recess 32. It can also protrude into it or even penetrate it in the direction of the rotational axis 20.

The bearing element 35 is now secured to the first housing shell 22, on the one hand and to the second housing shell 23, on the other. Securing is done by means of at least one screw 38, preferably by several screws 38. This is only shown here for the securing of the bearing element 35 to the second housing shell 23. Preferably, however, the corresponding embodiments are transferable to the securing of the bearing element 35 to the first housing shell 22. The screw(s) 38 is/are each shown to have a longitudinal center axis 39. The screw 38 or its longitudinal center axis 39 is now angled with respect to the contact plane 24 (not shown here). In particular, it is perpendicular to the contact plane 24. This means that the longitudinal center axis 39 of the screw 38 is preferably aligned parallel with the longitudinal center axis 26 of screw 25.

To support the bearing element 35 in the transmission housing 16, the screw 38 engages in a center dome 40 of the bearing element 35. The bearing projections 36 and 37 extend from the center dome 40 on opposite sides of the plane of symmetry.

Furthermore, a passage recess 41 for receiving the second input shaft 4 may be formed in the center dome 40, in particular between the bearing projections 36 and 37. Thus, the second input shaft 4 preferably penetrates completely the bearing element 35, in particular its passage recess 41 in the axial direction with respect to the rotational axes 17 and 18.

The ring-gear drives 6 and 9 are thus preferably designed, such that the ring gears 12 and 14 connected to the input shafts 2 and 4 are located on opposite sides of the bearing element 35, i.e., on opposite sides of a plane perpendicular to the rotational axes 17 and 18. In particular, the ring gear 12 is located completely on one side of this plane, and the ring gear 14 completely on the opposite side of the plane. The bearing element 35 is preferably designed in one piece and/or of the same material. For example, it is made of the same material as the housing shells 22 and 23. The use of the bearing element 35 allows for a particularly compact design of the final drive 1, in particular in the vertical direction.

FIG. 3 shows a schematic sectional view of the final drive 1, i.e., a cross section with respect to the rotational axes 17 and 19, wherein the section plane is perpendicular to the rotational axes 17 and 18 and preferably receives the rotational axes 19 and 20. The viewing direction aligned in the cross section toward the end 29. Input shafts 2 and 4 are not shown. It can be seen that each of the ring gears 13 and 15, or each of the output shafts 7 and 10 is mounted in the gear housing 16 by means of a bearing arrangement 42. The bearing assembly 42 for the ring gears 13 and 15 and the corresponding output shafts 7 and 10 are designed analogously, but in particular as mirror-inverted. In the following, the bearing assembly 42 for the ring gear 13 and the first output shaft 7 will be discussed in more detail. However, the embodiments are always transferable to the bearing assembly 42 for the ring gear 15 or the second output shaft 10.

The bearing assembly 42 has a first radial bearing 43 and a second radial bearing 44. These are arranged in an O-configuration relative to one another. Alternatively, they may also be designed as fixed bearings and as floating bearings. In the latter case, one of the radial bearings 43 and 44 forms the fixed bearing, and the other radial bearings 43 and 44 form the floating bearing. The O-configuration shown here will, however, be discussed in more detail in the following. However, the embodiments are always transferable to the embodiment of the radial bearings 43 and 44, as a fixed bearing and floating bearings. The radial bearings 43 and 44 are preferably designed as rolling bearings, in particular as ball bearings.

The radial bearings 43 and 44 are both arranged on the first bearing projection 36.

This means that they rest with their inner rings 45 and 46 on the first bearing projection 36. Outer rings 47 and 48 of the radial bearings 43 and 44, however, are arranged in the ring gear 13 and/or the first output shaft 7. Accordingly, the outer rings 47 and 48 rest against an inner bearing surface 49 of the ring gear 13 or the first output shaft 7. The intention is that the first radial bearing 43 is supported in the axial direction relative to the rotational axis 19 on the center axis 40 of the bearing element 35. In other words, the first radial bearing 43 is arranged in the axial direction relative to the rotational axis 19 between the center dome 40 and the ring gear 13 or an axial bearing projection 50 of the ring gear 13. In particular, the radial bearing 43 rests permanently against the center dome 40 and, besides, permanently against the axial bearing projection 50.

The second radial bearing 44 is preferably fixed axially outward by means of fasteners 51, i.e., in a direction away from the center dome 40. As fastener 51, e.g., a snap ring. or the like, is used. In particular, the fastener 51 is re-releasable. The radial bearing 44 is preferably arranged between the fastener 51 and the ring gear 13 or an axial bearing projection 52 of the ring gear 13 or the first output shaft 7. The second radial bearing 44 preferably rests permanently on the fastener 51, as well as permanently on the axial bearing projection 52.

The thrust bearing projections 50 and 52 may be different from one another and in particular spaced apart in the axial direction. However, the thrust bearing projections 50 and 52 can also be designed as a combined thrust bearing projection, wherein the first radial bearing 43 is located on one side and the second radial bearing 44 is located on the axially opposite side of this combined axial bearing project. It becomes obvious that the bearing assembly 42, i.e., both the first radial bearing 43 and the second radial bearing 44, are only secured to the transmission housing 16 via the bearing element 35. The radial bearings 43 and 44 thus engage exclusively via the bearing element 35 on the transmission housing 16.

Furthermore, it can be seen that the first bearing projection 36 has a first area 53 and a second area 54, which differ in terms of their diameter. Thus, the first bearing projection 36 has a first diameter in the first area 53 and a second diameter in the second area 54, whereby the first diameter is greater than the second diameter. The first area 53 preferably directly adjoins the center dome 40, at any rate it is arranged on the side of the second area 54 facing the center dome 40. The two areas 53 and 54 preferably adjoin one another directly in the axial direction with respect to the rotational axis 19.

The first radial bearing 43 is now seated in the first area 53 and the second radial bearing 44 is seated in the second area 54 on the first bearing projection 36. Thus, the inner ring 45 has a larger diameter than the inner ring 46. Preferably, the radial bearings 43 and 44 are of the same size in the radial direction, such that the outer ring 47 has a larger diameter than does the outer ring 48, analogously to the inner rings 45 and 46. However, the radial bearings 43 and 44 may, of course, be selected, such that the difference in diameter between the inner rings 45 and 46 differs from the difference in diameter of the outer rings 47 and 48. For example, the inner rings 45 and 46 are designed with different diameters, while the outer rings 47 and 48 have the same diameter.

FIG. 4 shows a second embodiment of the final drive 1, again in a sectional view. Basically, reference is made to the above explanations and below only the differences are discussed. These differences are due to the radial bearings 43 and 44 of the bearing assembly 42 now being in a tandem arrangement to one another. Alternatively, having the radial bearings 43 and 44 in an X-arrangement or—as explained above—designing the radial bearings 43 and 44 as fixed bearings and floating bearings would also be possible. The tandem arrangement is discussed in more detail below. However, the embodiments are transferable to the X-arrangement and design is transferable as a fixed bearing and a floating bearing.

The first radial bearing 43 is arranged analogously to the first embodiment of the final drive 1. Accordingly, it is seated with its inner ring 45 on the first bearing projection 36 In the axial direction, it is preferably supported, on the one hand, on the central dome 40, and on the axial bearing projection 50, on the other. However, differences with regard to the second radial bearing 44 exist. It is seated with its inner ring 45 on an outer bearing surface 55 of the ring gear 13 and the first output shaft 7. Thus, while the first radial bearing 43 engages in the ring gear 13 and the output shaft 7, respectively, the second radial bearing 44 engages around the ring gear 13 and the output shaft 7, respectively. Consequently, the first bearing projection 36 may be shorter and have a uniform diameter. The fastener 51 can also be omitted.

On the one hand, the second radial bearing 44 engages at the ring gear 13 and the output shaft 7, respectively, and directly at the gear housing 16, in particular at both housing shells 22 and 23, on the other. The thrust bearing projection 52 is now formed by a contact shoulder of the ring gear 13 and the output shaft 7, respectively. This, in turn, can be represented by a change in diameter. To secure the second radial bearing 44 in the axial direction relative to the transmission housing 16, at least toward the outside, the gear housing 16 likewise has an axial bearing projection 56. It is preferably formed both on the first housing shell 22 and the second housing shell 23. The second radial bearing 44 is now located between the axial bearing projection 52 and the axial bearing projection 56 in the axial direction relative to the rotational axis 19. Particularly preferably, it rests permanently on the axial bearing projection 52, as well as permanently against the axial bearing projection 56.

FIG. 5 shows a first variant of a third embodiment of the final drive 1. A schematic cross-sectional view according to the above explanations is again shown here. The bearing assembly 42 is analogous to the second embodiment described above. However, a bearing assembly 42 according to the first embodiment may also be used. Reference is made to the above explanations. In the following, only the differences to the first two embodiments are discussed. These are due to the fact that the ring gears 13 and 15 and thus the rotational axes 19 and 20 are not parallel to one another, but rather angled against one another.

This means that the rotational axes 19 and 20 continue to intersect the rotational axes 17 and 18 in the intersection points 33 and 34, whereby the intersection points 33 and 34 may coincide. In general terms, the rotational axes 19 and 20 each intersect both rotational axes 17 and 18. The rotational axes 19 and 20 may also intersect each other or alternatively be arranged obliquely to one another, in particular spaced parallel to one another. In a first variant shown here, the rotational axes 19 and 20 intersect. The rotational axes 19 and 20 are each angled at the same angle relative to the axial plane 21 and the contact plane 24, respectively, such that the plane perpendicular to the contact plane 24, and receiving the rotational axes 17 and 18, serves as the plane of symmetry for the rotational axes 19 and 20.

FIG. 6 shows a second variant of the third embodiment. A sectional view of the final drive is shown here, i.e., a longitudinal section with respect to the rotational axis 17 and 18. The sectional plane is chosen, such that the view is toward the first housing shell 22. Reference is expressly made to the above explanations. In addition thereto, the ring gears 12 and 14 of the ring gears 6 and 9 are now clearly seen as arranged on opposite sides of the bearing element 35. As already explained above, the second input shaft 4 thus engages through bearing element 35, in particular it engages through the passage recess 41. A direction of travel of a motor vehicle, with which the final drive 1 is associated, is indicated by the arrow 57.

In addition to or alternatively to the first variant described above, in which the rotational axes 19 and 20 are angled with respect to the axial plane, it can now be provided that the rotational axes 19 and 20 are also offset in the axial direction with respect to the rotational axes 17 and 18. For example, the ring-gear drives 6 and 9 are designed, such that a cone angle, which is different from 90°, is present.

Within the scope of the embodiments described above and the first variant, however, the cone angle is preferably equal to 90°. The displacement of the rotational axes 19 and 20 in the axial direction relative to one another results in two intersecting points 33 and 34 spaced apart from one another.

The described final drive 1 makes possible an extremely compact design. This applies in particular, if a further transmission unit, in particular a differential gear, preferably an axle differential gear, is arranged on the side of the input shafts 2 and 4 facing away from the axle gear 1. Final drive 1 is therefore only used to establish permanent active connections between the first input shaft 2 and the first output shaft 7, on the one hand, and the second input shaft 4 and the second output shaft 10, on the other.

1-10. (canceled)

11. A final drive for a motor vehicle, comprising:
a first input shaft, a second input shaft, a first output shaft and a second output shaft, wherein the first input shaft is permanently coupled to the first output shaft by a first ring-gear drive and the second input shaft is permanently coupled to the second output shaft by a second ring-gear drive,
wherein the first input shaft and the second input shaft are arranged coaxially with one another, and the first output shaft and the second output shaft extend in opposite directions from the respective ring-gear drive, wherein an axial plane accommodate the rotational axes of the input shafts and a plane perpendicular to the axial plane with the rotational axes of the output shafts forms an angle of at least 75° and at most 90°, and
in that a bearing element secured to the gear housing is arranged in a transmission housing of the final drive, which bearing element has a first bearing projection and a second bearing projection, wherein a first ring gear rigidly connected to the first output shaft is mounted on the first bearing projection, and a second ring gear of the second ring-gear drive rigidly connected to the second output shaft is mounted on the second bearing projection.

12. The final drive according to claim 11, wherein the rotational axes of the two input shafts and the rotational axes of the two output shafts lie in the axial plane.

13. The final drive according to claim 11, wherein the first bearing projection protrudes in the direction of a first outlet recess of the transmission housing, and the second bearing projection protrudes in the direction of a second outlet recess of the transmission housing or protrudes into it.

14. The final drive according to claim 11, wherein the gear housing has a first housing shell and a second housing shell, which are formed separately from each other and in a contact plane abut one another, in the axial plane or parallel thereto.

15. The final drive according to claim 11, wherein the bearing element is secured to the first housing shell, as well as to the second housing shell, in particular on opposite sides of the contact plane and/or by means at least one screw, whose longitudinal center axis is angled relative to the contact plane and/or is perpendicular thereto.

16. The final drive according to claim 11, wherein the bearing element is secured to the first housing shell or the second housing shell on either side of an imaginary plane, which is arranged perpendicularly on the contact plane and accommodates an intersection point of the rotational axes of the output shafts with the rotational axes of the input shafts.

17. The final drive according to claim 11, wherein the first input shaft and the second input shaft, as well as the first output shaft and the second output shaft are each mounted on or in the transmission housing.

18. The final drive according to claim 11, wherein the first input shaft and the second input shaft are mounted on and/or in the transmission housing on opposite sides of the ring-gear drive.

19. The final drive according to claim 11, wherein at least one bearing arrangement for supporting the first ring gear on the first bearing projection, and a second bearing arrangement for supporting the second ring gear on the second Bearing projection is arranged and/or secured in at least one direction by means of a fastener, in particular a snap ring.

20. The final drive according to claim 11, wherein the bearing element is designed in one piece and/or of the same material.

21. The final drive according to claim 12, wherein the first bearing projection protrudes in the direction of a first outlet recess of the transmission housing, and the second bearing projection protrudes in the direction of a second outlet recess of the transmission housing or protrudes into it.

22. The final drive according to claim 12, wherein the gear housing has a first housing shell and a second housing shell, which are formed separately from each other and in a contact plane abut one another, in the axial plane or parallel thereto.

23. The final drive according to claim 13, wherein the gear housing has a first housing shell and a second housing shell, which are formed separately from each other and in a contact plane abut one another, in the axial plane or parallel thereto.

24. The final drive according to claim 12, wherein the bearing element is secured to the first housing shell, as well as to the second housing shell, in particular on opposite sides of the contact plane and/or by means at least one screw, whose longitudinal center axis is angled relative to the contact plane and/or is perpendicular thereto.

25. The final drive according to claim 13, wherein the bearing element is secured to the first housing shell, as well as to the second housing shell, in particular on opposite sides of the contact plane and/or by means at least one screw, whose longitudinal center axis is angled relative to the contact plane and/or is perpendicular thereto.

26. The final drive according to claim 14, wherein the bearing element is secured to the first housing shell, as well as to the second housing shell, in particular on opposite sides of the contact plane and/or by means at least one screw, whose longitudinal center axis is angled relative to the contact plane and/or is perpendicular thereto.

27. The final drive according to claim 12, wherein the bearing element is secured to the first housing shell or the second housing shell on either side of an imaginary plane, which is arranged perpendicularly on the contact plane and accommodates an intersection point of the rotational axes of the output shafts with the rotational axes of the input shafts.

28. The final drive according to claim 13, wherein the bearing element is secured to the first housing shell or the second housing shell on either side of an imaginary plane, which is arranged perpendicularly on the contact plane and accommodates an intersection point of the rotational axes of the output shafts with the rotational axes of the input shafts.

29. The final drive according to claim 14, wherein the bearing element is secured to the first housing shell or the second housing shell on either side of an imaginary plane, which is arranged perpendicularly on the contact plane and accommodates an intersection point of the rotational axes of the output shafts with the rotational axes of the input shafts.

30. The final drive according to claim 15, wherein the bearing element is secured to the first housing shell or the second housing shell on either side of an imaginary plane, which is arranged perpendicularly on the contact plane and accommodates an intersection point of the rotational axes of the output shafts with the rotational axes of the input shafts.
